(19) United States
(12) Patent Application Publication
(10) Pub. No.: US 2007/0178228 A1
(43) Pub. Date: Aug. 2, 2007

(54) Method for fabricating a PCB

(76) Inventors: Hei Ming Shiu, Hong Kong (HK); On Lok Chau, Hong Kong (HK); Ho Wang Wong, Hong Kong (HK)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/341,281

(22) Filed: Jan. 27, 2006

(51) Int. Cl. B05D 1/12; B05D 5/12; B01J 19/08; B29C 71/04

(52) U.S. Cl. 427/96.1; 427/180; 427/532; 427/457

(57) ABSTRACT

A method for forming a metal layer on a substrate begins by providing a resin film on the substrate. An organic photo conductor layer having charged and uncharged segments is adhered to the resin film. Metal powder is deposited onto the charged segments of the organic photo conductor layer after which it is heated to form the metal layer.

### BACKGROUND OF THE INVENTION

The present invention relates generally to printed circuit boards (PCBs). More particularly, the present invention relates to an apparatus and a method for fabricating a PCB without using wet chemicals.

A printed circuit board (PCB) is a flat board or substrate, which is used to support semiconductor chips and other electronic components. The substrate includes a sheet of insulator or dielectric material having a number of conductive traces that are used to interconnect the electronic components. The traces are typically formed on the insulator by laminating a layer of copper foil over the substrate. A photoresist layer is formed on the copper foil. Excess copper is then removed from by chemical etching, leaving only the desired copper traces. Finally, electronic components may be soldered to the traces.

The process may also be repeated to fabricate a multi-layer PCB, which comprises alternating layers of conductive and dielectric material bonded together. To connect one conductive layer to another, holes are drilled through the PCB and plated with a conductive substance. These plated through holes (PTHs) are also commonly referred to as vias. In current circuit designs, thousands of vias may be used to form a complex system of interconnections for circuit elements located in stacks of conductive layers. To improve the speed and performance of a chip, engineers constantly strive to shrink circuit designs so that each chip may support more elements with shorter conductive lines.

Some of the problems with traditional PCB fabrication are inherent in the commonly used processes of drilling, chemical etching, and electroplating. Because drilling is a mechanical process, high precision equipment is required to form the tiny PTHs required. Currently, it is difficult to form a via that is as small as 75 μm in diameter. Since engineers are constantly striving to reduce the size of the circuitry in all electronics to improve performance and speed, this is a limiting factor.

In addition, both chemical etching and electroplating are expensive and difficult to control processes that involve wet chemicals, which may in turn generate hazardous wastes. In particular, it is expensive to electroplate a tiny PTH wall surface. Furthermore, when vias are electroplated, they are typically not completely filled with metal. Because they are not filled, there may be undesirable air bubbles in the via that may expand during heating and crack the substrate and conductive traces.

Accordingly, it would be desirable to have a method and an apparatus to fabricate PCBs without using expensive mechanical or chemical processes. In particular, it would be desirable to improve the resolution of the circuit traces on the PCB in a process that does not use wet chemicals.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a cross-sectional view of a semiconductor substrate in accordance with one embodiment of the present invention.

FIG. 2 is a cross-sectional view of the semiconductor substrate during metal powder deposition in accordance with one embodiment of the present invention.

FIG. 3 is a cross-sectional view of the semiconductor substrate after metal powder deposition in accordance with one embodiment of the present invention.

FIG. 4 is a cross-sectional view of a semiconductor substrate during formation of a metal layer in accordance with one embodiment of the present invention.

FIG. 5 is a cross-sectional view of a printer for depositing metal powder on a substrate in accordance with one embodiment of the present invention.

FIG. 6 is a cross-sectional view of a multi-layer PCB substrate in accordance with one embodiment of the present invention.

### DETAILED DESCRIPTION OF THE INVENTION

A method and an apparatus for fabricating a PCB are provided. In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention.

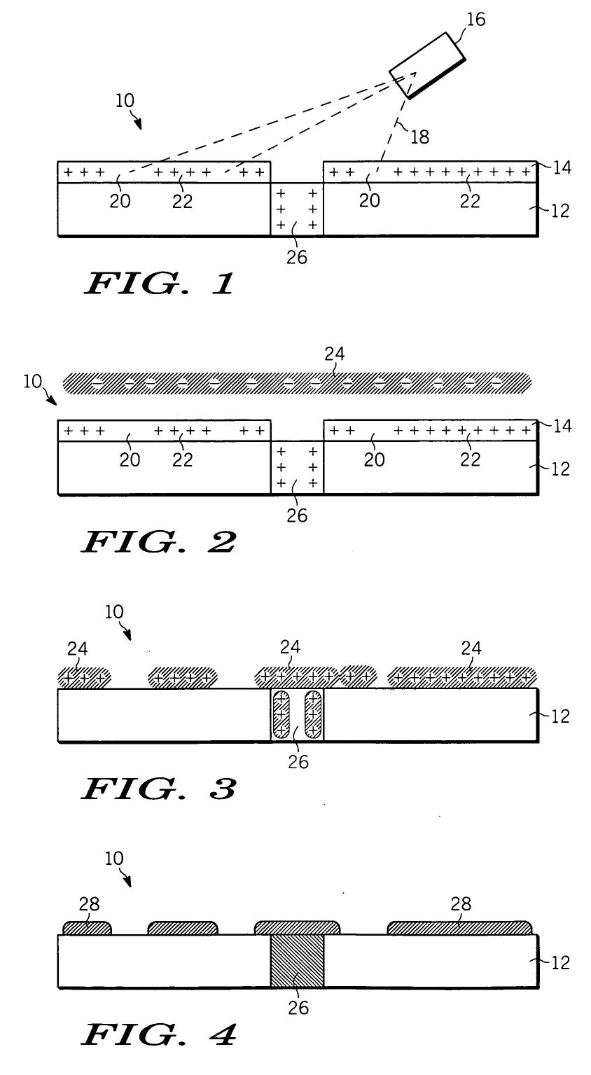

Referring now to FIG. 1, a cross-sectional view of a substrate 10 having a resin film 12 and an organic photo conductor (OPC) layer 14 in accordance with one embodiment of the present invention is shown. The substrate 10 may be formed from a sheet of insulator that is used to form the base of a PCB. The resin film 12, which is formed of a sticky substance like prepreg, may be laminated onto the substrate 10. The substrate 10 also includes at plurality of recesses 26. The OPC layer 14 is deposited on the resin film 12 and because the resin film 12 is formed of a sticky substance, the OPC layer 14 readily adheres to the resin film 12. An ionizer may then be used to charge the OPC layer 14.

To fabricate a pattern for the conductive traces of the PCB 10, a light source 16 is used generate a light beam 18 to selectively remove charge from the OPC layer 14 to form uncharged segments 20. By removing charge from selected portions of the OPC layer 14 to form the uncharged segments 20, unaltered charged segments 22 of the OPC layer 14 may be patterned to form an image of the desired conductive traces. Some examples of the light source 16 that are effective for removing charge from the OPC layer 14 include a laser and a light emitting diode (LED).

In one embodiment of the present invention, a programmable laser is used as the light source 16. The programmable laser generates the laser beam 18, which is used to selectively remove charge from the OPC layer 14 and form the uncharged segments 20. By using a programmable laser, the present invention is able to form charged segments 22 having a pitch of less than about 75 μm. If a state of the art laser printer having a low dot size is used, a pitch of less than about 50 μm may be achieved. Alternatively, the laser beam 18 may be directed through a masking plate (not shown) at the layer 14 to form the uncharged segments 20.

Referring now to FIG. 2, a cross-sectional view of the substrate 10 during metal powder deposition in accordance with one embodiment of the present invention is shown. After removing charge from selected portions of the OPC layer 14, a metal powder 24 is deposited onto the substrate 10. Examples of the metal powder 24 used to form conductive traces in a PCB include copper and various types of solder. The metal powder 24 preferably is charged so that it is attracted to the charged segments 22 of the OPC layer 14. For example, if the charged segments 22 are positively charged, as more commonly found in the OPC market, then the metal powder 24 should be negatively charged. The metal powder 24 preferably has a particle size of about 5 microns to about 10 microns.

Referring now to FIG. 3, a cross-sectional view of the substrate 10 after metal powder deposition in accordance with one embodiment of the present invention is shown. Because of the electrical attraction between the charged materials, the metal powder 24 moves toward and is deposited onto the charged segments 22 of the OPC layer 14. The metal powder 24 that is deposited onto the uncharged segments 20 of the OPC layer do not readily adhere thereto and such excess metal powder 24 is removed easily from the substrate 10 by air blowing or spinning.

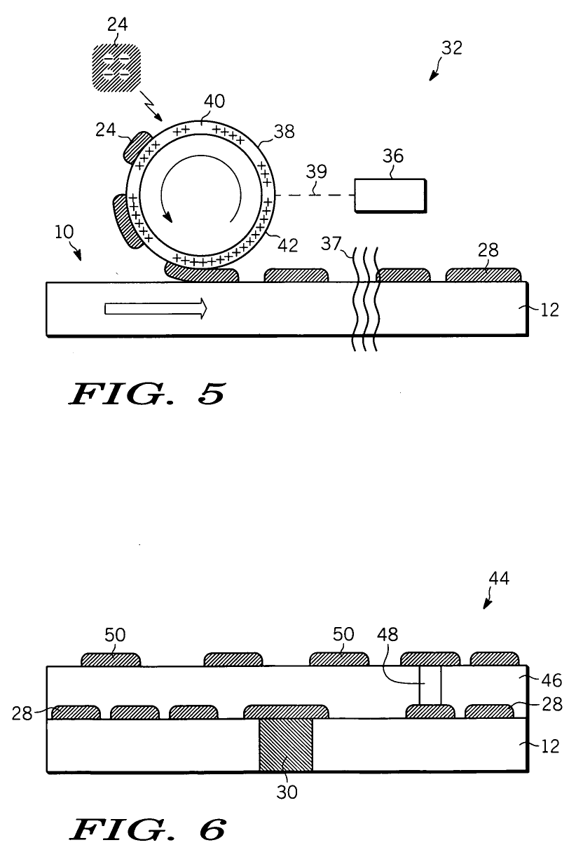

Referring now to FIG. 4, a cross-sectional view of the substrate 10 during formation of a metal layer 28 in accordance with one embodiment of the present invention is shown. After excess metal powder is removed from the substrate 10, the metal layer 28 is formed by melting the remaining metal powder 24 that has been deposited onto the charged segments 22 of the OPC layer 14. The metal powder 24 is heated to its melting point, which may be between about 150 degrees Celsius to about 300 degrees Celsius. If solder is used as the metal powder, then it is typically melted at about 180 degrees Celsius. The metal powder 24 is then cooled to form the metal layer 28. The recess 26 may also have melted metal powder therein and thus form a conductive via 30.

Referring now to FIG. 5, a cross-sectional view of a printer 32 for depositing the metal powder 24 onto the substrate 10 in accordance with one embodiment of the present invention is shown. The printer 32 includes a drum 34 having a surface disposed within range of a light source 36. The printer 32 may be a laser printer, in which case the light source 36 is a laser. The substrate 10 is disposed adjacent to the drum 34, so that the drum 34 is able to print the metal powder 24 onto the substrate 10. The printer 32 may also include a heat source 37, though it should be understood that heat may be supplied from sources outside the printer 32.

To prepare the printer 32 for depositing the metal powder 24, an OPC layer 38 may be formed on the surface of drum 34. For ease of illustration, the OPC layer 38 is not drawn to scale and is typically only a few microns in thickness. The OPC layer 38 is given an electric charge, for example a uniform positive charge throughout by an ionizer (not illustrated) that is integrated with the printer 32. To determine where the metal powder 24 is to be deposited onto the substrate 10, the light source 36 is used to selectively remove charge from the OPC layer 38. A laser beam 39 is generated by the light source 36 and directed onto selected portions of the surface of the drum 34 to form uncharged sections 40, while leaving charged sections 42 undisturbed. The laser beam 39 is directed at the OPC layer 38 both by the light source 36 and by turning the drum 34. The charged sections 42 of the OPC layer 38 then form a pattern of the conductive traces desired on the substrate 10.

After forming the uncharged sections 40, the positively charged sections 42 attract the negatively charged metal powder 24 such that the negatively charged metal powder 24 adheres to the charged sections 42. The metal powder 24 may be stored in and released from a reservoir (not illustrated). The drum 34 is then used to print the metal powder 24 onto the resin film 12 as the substrate 10 is moved through the printer 32. When the printing process is finished, the substrate 10 is heated in order to melt the metal powder 24 to form the metal layer 28. In some instances, as will be understood by persons skilled in the art, pressure may also be used to aid in forming the metal layer 28.

Referring now to FIG. 6, a cross-sectional view of a multi-layer PCB 44 formed in accordance with one embodiment of the present invention is shown. To form a second conductive layer in the PCB 44, a second layer of resin film 46 is laminated over the first resin film 12 and the first metal layer 28. Second recesses 48 may be formed in the second resin film 46, such as by drilling or with a light (laser) beam.

To form a second metal layer 50, the processes of the present invention described above may be repeated. For example, using the direct paint method described in FIGS. 1-4, the second resin film 46 is coated with charged OPC to attract metal powder. After the metal powder is deposited onto the charged OPC, the metal powder is then melted to form the second metal layer 50. Additional metal layers may be formed in the PCB 44 by repeating the same process.

One advantage of the present invention is that conductive traces may be formed by metal powder deposition instead of chemical etching and electroplating. Because wet chemicals are not involved, the present invention avoids having to use and control hazardous materials inherent in the traditional process. In addition, because the present invention creates vias by filling drill holes with metal powder, the expensive PTH process is eliminated. Another advantage of the present invention is that it is able to fabricate traces on a PCB having fine geometry (pitch less than about 50 μm), which may be used to build faster and more efficient circuits.

Other embodiments of the invention will be apparent to those skilled in the art from consideration of the specification and practice of the invention. Furthermore, certain terminology has been used for the purposes of descriptive clarity, and not to limit the present invention. The embodiments and preferred features described above should be considered exemplary, with the invention being defined by the appended claims.

1. A method of forming a metal layer on a substrate, comprising:
providing a resin film on the substrate;
providing an organic photo conductor layer on the resin film, wherein the organic photo conductor layer includes charged segments and uncharged segments;
depositing a metal powder on the charged segments of the organic photo conductor layer; and
heating the metal powder to form the metal layer.

2. The method of forming a metal layer on a substrate of claim 1, further comprising removing charge from the organic photo conductor layer by directing light at the organic photo conductor layer to form the uncharged segments.

3. The method of forming a metal layer on a substrate of claim 2, wherein the organic photoconductor layer has a positive charge and the metal powder has a negative charge.

4. The method of forming a metal layer on a substrate of claim 2, wherein the light is a laser generated by a programmable laser source.

5. The method of forming a metal layer on a substrate of claim 1, wherein the metal layer included traces having a pitch of less than about 50 μm.

6. The method of forming a metal layer on a substrate of claim 5, wherein the metal powder is one of copper alloy and solder.

7. The method of forming a metal layer on a substrate of claim 6, wherein the metal powder has a particle size of between about 5 μm to about 10 μm.

8. The method of forming a metal layer on a substrate of claim 6, wherein the metal powder is heated to its melting point, wherein said melting point is between about 150 degrees Celsius to about 300 degrees Celsius.

9. The method of forming a metal layer on a substrate as recited in claim 6, wherein the metal powder is deposited into a recess defined in the substrate to form a via.

10. A method for forming a metal layer on a substrate, comprising:
providing a resin film on the substrate;
providing an organic photo conductor layer, wherein the organic photo conductor has a charge;
selectively removing charge from the organic photo conductor layer to form uncharged segments;
depositing a metal powder on charged segments of the organic photo conductor layer, wherein the metal powder is attracted to the charged segments;
depositing the organic photo conductor layer and the metal powder on the substrate; and
heating the metal powder to form the metal layer.

11. The method for forming a metal layer on a substrate as recited in claim 10, wherein the charged sections of the organic photoconductor layer have a positive charge and the metal powder has a negative charge.

12. The method for forming a metal layer on a substrate as recited in claim 11, wherein the charge is selectively removed by directing a laser at the organic photo conductor layer.

13. The method for forming a metal layer on a substrate as recited in claim 12, wherein the metal layer includes metal traces having a pitch of less than about 50 μm.

14. The method for forming a metal layer on a substrate as recited in claim 13, wherein the metal powder is one of copper alloy and solder.

15. The method for forming a metal layer on a substrate as recited in claim 14, wherein the metal powder has a particle size of between about 5 μm to about 10 μm.

16. The method for forming a metal layer on a substrate as recited in claim 15, wherein the metal powder is heated to between about 150 degrees Celsius to about 300 degrees Celsius.

17. A method for forming a metal layer on a substrate, comprising:
providing a resin film on the substrate;
providing an organic photo conductor layer on a drum of a laser printer;
charging the organic photo conductor;
selectively removing charge from the organic photo conductor layer to form charged segments and uncharged segments;
depositing metal powder on the charged segments of the organic photo conductor layer;
rotating the drum to deposit the organic photo conductor layer and the metal powder onto the substrate; and
heating the metal powder to form the metal layer.

18. The method of forming a metal layer on a substrate as recited in claim 17, wherein the organic photo conductor is charged by an ionizer of the laser printer.

19. The method of forming a metal layer on a substrate as recited in claim 18, wherein the charge is removed by directing a laser at the organic photo conductor layer.

20. The method of forming a metal layer on a substrate as recited in claim 19, wherein the metal layer includes traces having a pitch of less than about 50 μm.
